(19) United States
(12) Patent Application Publication
(10) Pub. No.: US 2020/0204952 A1
(43) Pub. Date: Jun. 25, 2020

(54) PREDICTION BASED MESSAGE TRANSMISSON TRIGGERING

(71) Applicant: Telefonaktiebolaget LM Ericsson (publ), Stockholm (SE)

(72) Inventor: Stefano Sorrentino, Solna (SE)

(21) Appl. No.: 16/608,681

(22) PCT Filed: Apr. 27, 2018
(86) PCT No.: PCT/EP2018/060993

§ 371 Date: Oct. 25, 2019

Related U.S. Application Data
(60) Provisional application No. 62/501,270, filed on May 4, 2017.

(51) Int. Cl. H04W 4/02; H04W 4/029; H04W 4/44; G08G 1/0967; G08G 1/16; G06N 5/04; H04L 29/08

(52) U.S. Cl. CPC H04W 4/027; H04W 4/029; H04W 4/44; H04L 67/12; G08G 1/164; G06N 5/04; G08G 1/096775

(57) ABSTRACT

According to some embodiments, a method in a wireless device comprises: detecting, at a first time period, a first status of an object based on dynamic properties of the object (e.g., a heading, a location, a speed, an acceleration, etc.); communicating the first status of the object to a network element; predicting, at a second time period after the first time period, a status of the object based on the first status of the object; detecting, at the second time period, a second status of the object based on dynamic properties of the object; and upon determining that the predicted status is different than the second status, communicating the second status (e.g., CAM, DENM, etc.) to the network element.

### TECHNICAL FIELD

Particular embodiments are directed to wireless communications and, more particularly, to triggering message transmissions based on predicted versus actual dynamics of a wireless device or sensor.

### INTRODUCTION

Third Generation Partnership Project (3GPP) long term evolution (LTE) Release 12 supports device to device (D2D) (also referred to as “sidelink”) features targeting both commercial and public safety applications. Some applications include device discovery, where devices establish a connection with another device in the proximity by broadcasting and detecting discovery messages that carry device and application identities. Another application includes direct communication based on physical channels terminated directly between devices. In 3GPP, these applications are defined under the umbrella of Proximity Services (Pro S e).

One extension of the ProSe framework includes V2X communication, which includes any combination of direct communication between vehicles, pedestrians and infrastructure. V2X communication may take advantage of a network infrastructure, when available, but basic V2X connectivity may be possible even in case of lack of coverage. Providing an LTE-based V2X interface may be economically advantageous because of the LTE economies of scale. The LTE-based V2X interface may facilitate tighter integration between communications with the network infrastructure (V2I), pedestrians (V2P), and other vehicles (V2V) communications, as compared to using a dedicated V2X technology. Ongoing research projects and field tests of connected vehicles are occurring in various countries or regions, includes projects based on existing cellular infrastructure.

V2X communications may carry both safety and non-safety information. Each of the applications and services may be associated with specific requirements sets (e.g., in terms of latency, reliability, capacity, etc.). From the application point of view, V2X includes the following types of communication/services V2V, V2I, V2P and V2N. An example is illustrated in FIG. 1.

FIG. 1 illustrates various types of V2X communication. For example, FIG. 1 illustrates communication between a vehicle and a network (V2N), a vehicle and a person (V2P) such as a pedestrian, a vehicle and infrastructure (V2I) such as the illustrated traffic signal, and a vehicle to another vehicle (V2V).

V2V (vehicle to vehicle) refers to communication between vehicles using V2V applications and is predominantly broadcast-based. V2V may be realized by either direct communication between the devices in the respective vehicles, or via infrastructure such as a cellular network.

An example of V2V is the transmission of a cooperative awareness message (CAM) with vehicle status information (such as position, direction and speed) transmitted to other vehicles in the proximity repeatedly (every 100 ms-1 s). Another example is the transmission of a decentralized environmental notification message (DENM), which is an event-triggered message to alert vehicles. These two examples are taken from the European Telecommunications Standards Institute (ETSI) Intelligent Transport Systems (ITS) specification of V2X applications, which also specifies the conditions under which the messages are generated. One characteristic of V2V applications is the tight requirements on latency that can vary from 20 ms (for pre-crash warning messages) to 100 ms for other road safety services.

V2I (vehicle to infrastructure) refers to communication between vehicles and a Roadside Unit (RSU). The RSU is a stationary transportation infrastructure entity which communicates with vehicles in its proximity. An example of V2I is transmission of speed notifications from the RSU to vehicles, as well as queue information, collision risk alerts, curve speed warnings. Because of the safety related nature of V2I, delay requirements are similar to V2V requirements.

V2P (vehicle to pedestrian) refers to communication between vehicles and vulnerable road users, such as pedestrians, using V2P applications. V2P typically takes place between distinct vehicles and pedestrians either directly or via infrastructure such as cellular network.

V2N (vehicle to network) refers to communication between a vehicle and a centralized application server (or an ITS Traffic Management Center) both using V2N applications, via infrastructure (such as a cellular network). Examples include a bad road condition warning sent to all vehicles in a wide area, or traffic flow optimization in which V2N application suggests speeds to vehicles and coordinates traffic lights.

Therefore, V2N messages are usually controlled by a centralized entity (i.e., the Traffic Management Center) and provisioned to vehicles in a large geographical area, rather than in a small area. Additionally, unlike V2V/V2I, latency requirements are more relaxed in V2N because it is used for non-safety purposes (e.g., a 1 second latency requirement may be typical).

The development of V2X standards, including the application layer, has been based on Institute of Electrical and Electronics Engineers (IEEE) 802.11p dedicated short-range communication (DSRC), such as in the ETSI Intelligent Transport Systems (ITS G5) and IEEE WAVE (Wireless Access in Vehicular Environments) families of specifications. These technologies are designed to operate in the 5.9 Ghz band.

The DSRC-based V2X communication inherently provides a short range (such as 250-500 m). Providing a wide area coverage relies on the deployment of Road-Side Units (RSUs), which may be used as a relay. Moreover, by connecting the DSRC-based RSU to a Traffic Management Center, V2N applications may be used over DSRC, as depicted in FIG. 2.

FIG. 2 illustrates DSRC-based V2X communication using road-side units (RSU). Traffic management center 8 may communicate with vehicles 10 over network 12. Road-side units 14 may relay communications from traffic management center 8 to vehicles 10 or between two or more vehicles 10. For example, traffic management center 8 may inform vehicle 10 of a crash between two other vehicles 10.

Besides providing pure relaying functionality, the RSU is also typically involved in Vehicle-to-Infrastructure (V2I) communication. Some of the use cases where the RSU is involved are, for example, V2I Emergency Stop, Queue Warning, Automated Parking System, and V2X road safety service via infrastructure.

Some V2X implementations use LTE. Because of the range limitations of DSRC and to avoid deploying a new and separate technology and/or wireless infrastructure only for V2X, reusing the cellular network for V2X communication is beneficial.

V2V communication relying exclusively on cellular network infrastructure, however, may not alone support all types of vehicular applications. For example, cellular infrastructure may not support applications involving rapid exchanges of information between a large numbers of cars in proximity. Thus, a direct wireless communication may still be used as a complement.

3GPP may use the Evolved Packet System (EPS), including LTE as a wireless technology, for V2X services. For example, Release 14 may include the support for V2X, as described in 3GPP TR 22.885 V14.0.0 (2015-12), Study on LTE support for Vehicle to Everything (V2X) services. Proximity-based Services (ProSe) (i.e., Device-to-Device communications, D2D), introduced in 3GPP Release 12, provides the basic functionality to support direct communication for V2X services over the sidelink (i.e., the direct link between UEs introduced in 3GPP Release 12). Furthermore, LTE-based broadcast services, such as eMBMS, could provide additional functionalities for V2X services. An example is illustrated in FIG. 3.

FIG. 3 illustrates examples of using LTE for V2X communication. Particular examples may include a mix of sidelink (D2D/PC5) and uplink/downlink. A vehicle in the V2X context will include a (vehicle) UE, which in turn provides a Uu interface as well as a PC5 interface, which corresponds to the sidelink interface. Moreover, both UE-based RSUs (providing PC5 connectivity with vehicle UEs) and eNB-based RSUs (providing only Uu connectivity with vehicle UEs) are two alternative realizations of the RSU.

Multicarrier operation may be beneficial for some D2D scenarios. For example, in V2X road safety use cases, receiving a particular message with sufficient reliability may be important. A transmitting V2X device can, for example, replicate a certain message on multiple carriers. One goal of ITS safety services is to reduce the number of traffic fatalities or accidents. This poses stringent requirements on communication reliability and interference environment in ITS safety channels. Another benefit is the possibility to increase the data rate of the sidelink, thereby opening D2D to a wider set of applications which demand higher data rate, for example infotainment services, autonomous driving, etc.

Additionally, V2X may operate at 5.9 Ghz where other ITS technologies, such as DSRC, are also operating. One possible transceiver configuration for a UE may support simultaneous transmission/reception at 5.9 Ghz in the ITS bands and in the LTE bands where coexistence with legacy Uu operation is a requirement.

A number of services, mostly but not exclusively related to road safety, can be provided by enabling awareness between mobile devices and other road elements, which may include vehicles and road infrastructure. The mobile devices may be embedded in vehicles or carried by pedestrians, cyclists, or even by vehicles passengers.

The examples described above of mobile devices communicating with other vehicles can be grouped in to two categories. A first category is direct communication, where the devices communicate directly with each other by use of a Sidelink, D2D, DSRC or other direct communication protocol. A second category is indirect communication, were the device transmits messages to the network infrastructure which forwards the messages to the interested receivers.

Cooperative awareness messages (CAM) are defined in terms of content and generation procedures by ETSI specifications EN 302 637-2 (which can be found at /deliver/etsi_en/302600_302699/30263702/01.03.02_60/en_30263702v010302p.pdf at www.etsi.org). The messages may carry position, speed and additional information about the transmitter. They are generated periodically with an inter-message interval between 100 ms and 1 s, depending on the kinetics of the transmitter. The CAM specification includes two trigger conditions.

1) The time elapsed since the last CAM generation is equal to or greater than T_GenCam_Dcc and one of the following ITS-S dynamics related conditions is given:

the absolute difference between the current heading of the originating ITS-S and the heading included in the CAM previously transmitted by the originating ITS-S exceeds 4°;

the distance between the current position of the originating ITS-S and the position included in the CAM previously transmitted by the originating ITS-S exceeds 4 m;

the absolute difference between the current speed of the originating ITS-S and the speed included in the CAM previously transmitted by the originating ITS-S exceeds 0.5 m/s.

2) The time elapsed since the last CAM generation is equal to or greater than T_GenCam and equal to or greater than T_GenCam_Dcc.

Similar principles may be considered for sensor sharing specifications. Devices may detect other vehicles (or other traffic-related elements) and share information about the detected elements with other vehicles or with an infrastructure server. All of the applications include the general principle that a message transmission is triggered by significant changes in the message content. Other ITS messages may be triggered according to similar principles.

A problem with the current capabilities, however, is that transmitting periodic messages every 100 ms to 1 s may significantly drain the battery for a mobile device and may in practice limit the deployment of associated services. A further problem is that the number of messages may be a significant burden for the network and a significant cost for the service providers. In fact, some services have not been deployed yet because of their excessive traffic load.

### SUMMARY

The embodiments described herein modify the messages transmission trigger conditions. It is assumed that the message provides information that is useful to predict/extrapolate the evolution of a status associated with the object. Instead of triggering a transmission when the status of the object changes, particular embodiments trigger a transmission when the actual status of the object differs from a predicted status of the object. Particular embodiments include corresponding actions by the message receiver.

According to some embodiments, a method in a wireless device comprises: detecting, at a first time period, a first status of an object based on dynamic properties of the object (e.g., a heading, a location, a speed, an acceleration, etc.); communicating (e.g., CAM, DENM, etc.) the first status of the object to a network element; predicting, at a second time period after the first time period, a status of the object based on the first status of the object; detecting, at the second time period, a second status of the object based on dynamic properties of the object; and upon determining that the predicted status is different than the second status, communicating the second status (e.g., CAM, DENM, etc.) to the network element.

In particular embodiments, determining that the predicted status is different than the second status comprises determining that the predicted status and the second status differ by at least a threshold amount. Predicting the status of the object may comprise a linear extrapolation of the first status.

In particular embodiments, the method further comprises upon determining a threshold amount of time has passed since communicating the first status of the object to the network element, communicating the second status to the network element.

In particular embodiments, the network element comprises another wireless device, a network node, or a cloud server.

In particular embodiments, the object is the wireless device, or the object is an object in proximity to the wireless device. The object may comprise a vehicle.

According to some embodiments, a wireless device comprises processing circuitry operable to: detect, at a first time period, a first status of an object based on dynamic properties (e.g., a heading, a location, a speed, an acceleration, etc.) of the object; communicate (e.g., CAM, DENM, etc.) the first status of the object to a network element; predict, at a second time period after the first time period, a status of the object based on the first status of the object; detect, at the second time period, a second status of the object based on dynamic properties of the object; and upon the processing circuitry determining that the predicted status is different than the second status, the processing circuitry is operable to communicate (e.g., CAM, DENM, etc.) the second status to the network element.

In particular embodiments, the processing circuitry is operable to determine that the predicted status and the second status differ by at least a threshold amount. The processing circuitry may be operable to predict the status of the object using a linear extrapolation of the first status.

In particular embodiments, the processing circuitry is further operable to, upon determining a threshold amount of time has passed since communicating the first status of the object to the network element, communicate the second status to the network element.

In particular embodiments, the object is the wireless device, or the object is an object in proximity to the wireless device. The network element comprises at least one of another wireless device, a network node, and a cloud server. The object may comprise a vehicle.

According to some embodiments, a method for use in a network element comprises: receiving (e.g., CAM, DENM, etc.), from a wireless device, a first status of an object at a first time period; updating a current status of the object using the first status; predicting, at a second time period after the first time period, a status of the object based on the first status of the object; updating the current status of the object using the predicted status; receiving (e.g., CAM, DENM, etc.) a second status of the object, the second status different than the predicted status; and updating the current status of the object using the second status.

In particular embodiments, the first status of the object is based at least on one of a heading, a location, a speed, and an acceleration. Predicting the status of the object may comprise a linear extrapolation of the first status.

In particular embodiments, the network element comprises at least one of a wireless device, a network node, and a cloud server.

In particular embodiments, the object is the wireless device or an object in proximity to the wireless device. The object may comprise a vehicle.

According to some embodiments, a network element comprises processing circuitry operable to: receive, from a wireless device, a first status of an object at a first time period; update a current status of the object using the first status; predict, at a second time period after the first time period, a status of the object based on the first status of the object; update the current status of the object using the predicted status; receive a second status of the object, the second status different than the predicted status; and update the current status of the object using the second status.

In particular embodiments, the first status of the object is based at least on one of a heading, a location, a speed, and an acceleration. The processing circuitry may be operable to predict the status of the object using a linear extrapolation of the first status.

In particular embodiments, the network element comprises at least one of a wireless device, a network node, and a cloud server.

In particular embodiments, the object is the wireless device or an object in proximity to the wireless device. The object may comprise a vehicle.

According to some embodiments, a wireless device comprises a detecting module, a predicting module, and a communicating module. The detecting module is operable to detect, at a first time period, a first status of an object based on dynamic properties of the object. The communicating module is operable to communicate the first status of the object to a network element. The predicting module is operable to predict, at a second time period after the first time period, a status of the object based on the first status of the object. The detecting module is further operable to detect, at the second time period, a second status of the object based on dynamic properties of the object. Upon the processing circuitry determining that the predicted status is different than the second status, the communicating module is further operable to communicate the second status to the network element.

According to some embodiments, a network element comprises a receiving module and a predicting module. The receiving module is operable to receive, from a wireless device, a first status of an object at a first time period. The predicting module is operable to: update a current status of the object using the first status; predict, at a second time period after the first time period, a status of the object based on the first status of the object; and update the current status of the object using the predicted status. The receiving module is further operable to receive a second status of the object, the second status different than the predicted status. The predicting module is further operable to update the current status of the object using the second status.

Also disclosed is a computer program product. The computer program product comprises instructions stored on non-transient computer-readable media which, when executed by a processor, perform the steps of: detecting, at a first time period, a first status of an object based on dynamic properties of the object (e.g., a heading, a location, a speed, an acceleration, etc.); communicating (e.g., CAM, DENM, etc.) the first status of the object to a network element; predicting, at a second time period after the first time period, a status of the object based on the first status of the object; detecting, at the second time period, a second status of the object based on dynamic properties of the object; and upon determining that the predicted status is different than the second status, communicating the second status (e.g., CAM, DENM, etc.) to the network element.

Another computer program product comprises instructions stored on non-transient computer-readable media which, when executed by a processor, perform the steps of: receiving (e.g., CAM, DENM, etc.), from a wireless device, a first status of an object at a first time period; updating a current status of the object using the first status; predicting, at a second time period after the first time period, a status of the object based on the first status of the object; updating the current status of the object using the predicted status; receiving (e.g., CAM, DENM, etc.) a second status of the object, the second status different than the predicted status; and updating the current status of the object using the second status.

Particular embodiments may exhibit some of the following technical advantages. For example, particular embodiments include significant reduction of the signaling associated with awareness messages by relying on a model of the underlying kinetics. Other technical advantages will be readily apparent to one skilled in the art from the following figures, description and claims.

### BRIEF DESCRIPTION OF THE DRAWINGS

For a more complete understanding of the embodiments and their features and advantages, reference is now made to the following description, taken in conjunction with the accompanying drawings, in which:

FIG. 1 illustrates various types of V2X communication;

FIG. 2 illustrates DSRC-based V2X communication using road-side units (RSU);

FIG. 3 illustrates examples of using LTE for V2X communication;

FIG. 4 is a block diagram illustrating an example wireless network, according to some embodiments;

FIG. 5 is a flow diagram illustrating an example method in a wireless device, according to some embodiments;

FIG. 6 is a flow diagram illustrating an example method in a network element, according to some embodiments;

FIG. 7A is a block diagram illustrating an example embodiment of a wireless device;

FIG. 7B is a block diagram illustrating example components of a wireless device;

FIG. 8A is a block diagram illustrating an example embodiment of a network node;

FIG. 8B is a block diagram illustrating example components of a network node;

FIG. 9A is a block diagram illustrating an example embodiment of a cloud server; and

FIG. 9B is a block diagram illustrating example components of a cloud server.

### DETAILED DESCRIPTION

Third Generation Partnership Project (3GPP) long term evolution (LTE) Release 12 supports device to device (D2D) (also referred to as “sidelink”) features targeting both commercial and public safety applications. In 3GPP, these applications are defined under the umbrella of Proximity Services (ProSe). One extension of the ProSe framework includes V2X communication, which includes any combination of direct communication between vehicles, pedestrians and infrastructure.

The development of V2X standards, including the application layer, has been based on IEEE 802.11p dedicated short-range communication (DSRC), such as in the ETSI Intelligent Transport Systems (ITS G5) and IEEE WAVE (Wireless Access in Vehicular Environments) families of specifications.

Cooperative awareness messages (CAM) may carry position, speed and additional information about the transmitter. They are generated periodically with an inter-message interval between 100 ms and 1 s, depending on the kinetics of the transmitter. For example, the CAM trigger conditions may be based on time interval as well as changes in heading, position, speed, etc. Other sensor sharing applications may include similar principles based on the dynamics of an object.

A problem with the current capabilities, however, is that transmitting periodic messages every 100 ms to 1 s may significantly drain the battery for a mobile device and may in practice limit the deployment of associated services. A further problem is that the number of messages may be a significant burden for the network and a significant cost for the service providers.

Particular embodiments obviate the problems described above and trigger a transmission when the actual status of the object differs from a predicted status of the object. Particular embodiments include significant reduction of the signaling associated with awareness messages by relying on a model of the underlying kinetics.

The following description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Particular examples are described with respect to CAM as specified by ETSI, but the embodiments described herein may extend to any type of message generated by a node whose status is dynamic (e.g., because of its movement). Intelligent Transportation Systems (ITS) include a number of message families having such characteristics, such as CAM, DENM, SPAT, BSM, etc. Similar messages may also be defined by proprietary protocols. Particular embodiments are also applicable to sensor sharing messages (i.e., messages carrying info associated to an object detected by the transmitting node).

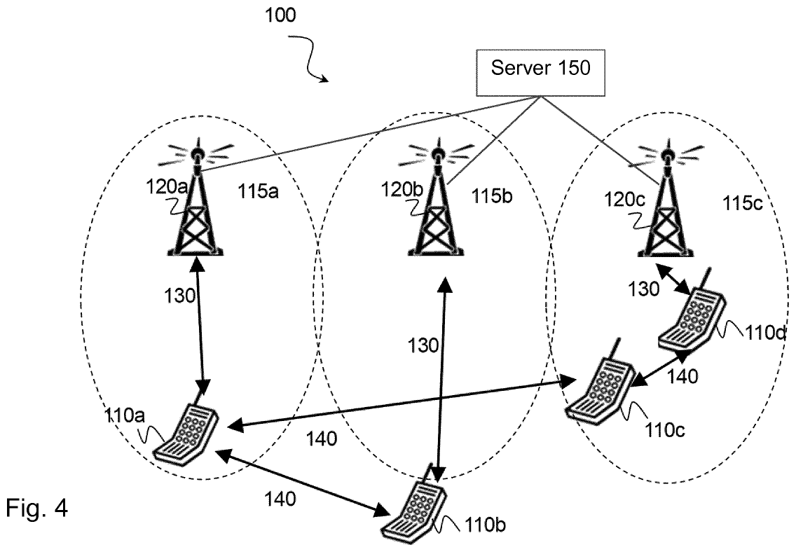

Particular embodiments are described with reference to FIGS. 4-9B of the drawings, like numerals being used for like and corresponding parts of the various drawings. LTE is used throughout this disclosure as an example cellular system, but the ideas presented herein may apply to other wireless communication systems as well (e.g., 5G NR, etc.).

FIG. 4 is a block diagram illustrating an example wireless network, according to a particular embodiment. Wireless network 100 includes one or more wireless devices 110 (such as mobile phones, smart phones, laptop computers, tablet computers, MTC devices, V2X devices, or any other devices that can provide wireless communication) and a plurality of network nodes 120 (such as base stations or eNodeBs). Wireless device 110 may also be referred to as a UE. Network node 120 serves coverage area 115 (also referred to as cell 115).

In general, wireless devices 110 that are within coverage of network node 120 (e.g., within cell 115 served by network node 120) communicate with network node 120 by transmitting and receiving wireless signals 130. For example, wireless devices 110 and network node 120 may communicate wireless signals 130 containing voice traffic, data traffic, and/or control signals.

A network node 120 communicating voice traffic, data traffic, and/or control signals to wireless device 110 may be referred to as a serving network node 120 for the wireless device 110. Communication between wireless device 110 and network node 120 may be referred to as cellular communication. Wireless signals 130 may include both downlink transmissions (from network node 120 to wireless devices 110) and uplink transmissions (from wireless devices 110 to network node 120). In LTE, the interface for communicating wireless signals between network node 120 and wireless device 110 may be referred to as a Uu interface.

Each network node 120 may have a single transmitter or multiple transmitters for transmitting signals 130 to wireless devices 110. In some embodiments, network node 120 may comprise a multi-input multi-output (MIMO) system. Similarly, each wireless device 110 may have a single receiver or multiple receivers for receiving signals 130 from network nodes 120 or other wireless devices 110.

Wireless devices 110 may communicate with each other (i.e., D2D operation) by transmitting and receiving wireless signals 140. For example, wireless device 110a may communicate with wireless device 110b using wireless signal 140. Wireless signal 140 may also be referred to as sidelink 140. Communication between two wireless devices 110 may be referred to as D2D communication or sidelink communication. In LTE, the interface for communicating wireless signal 140 between wireless device 110 may be referred to as a PC5 interface.

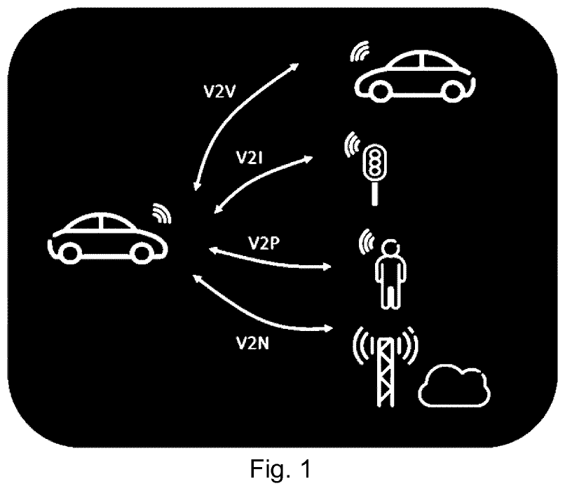

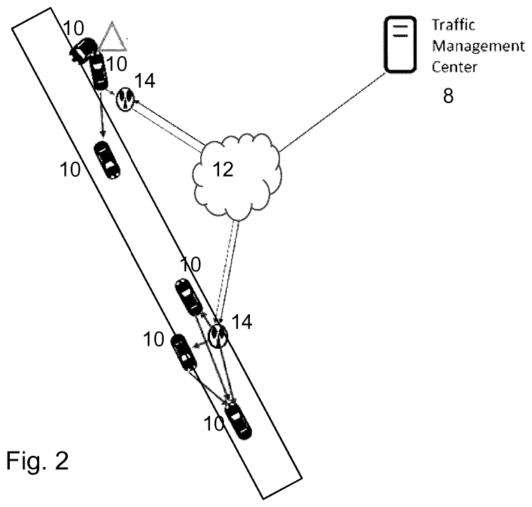

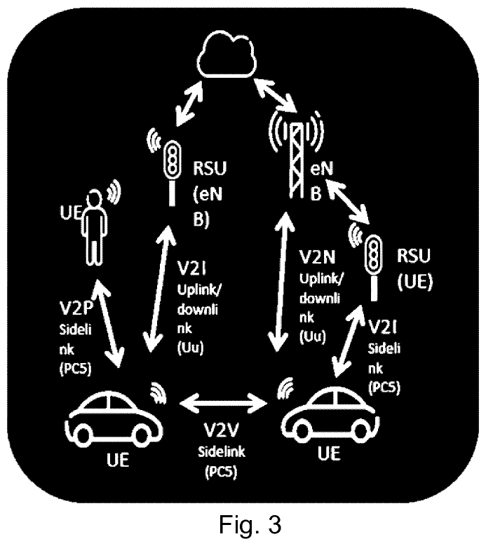

In particular embodiments, wireless signal 140 may use a different carrier frequency than the carrier frequency of wireless signal 130. For example, wireless device 110a may communicate with network node 120a using a first frequency band and may communicate with wireless device 110b using the same frequency band or a second frequency band. Wireless devices 110a and 110b may be served by the same network node 120 or by different network nodes 120. In particular embodiments, one or both of network nodes 110a and 110b may be out-of-coverage of any network node 120. Wireless signals 130 and 140 may include any of the V2X communications described with respect to FIGS. 1-3.

Network 100 may include server 150. In certain embodiments, server 150 may interface with the other components of network 100 (e.g., wireless device 110, network node 120, etc.) via an interconnecting network. The interconnecting network may refer to any interconnecting system capable of transmitting audio, video, signals, data, messages, or any combination of the preceding. The interconnecting network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof. Server 150 may comprise, for example, any of the V2X components described with respect to FIGS. 1-3, such as an RSU or traffic management center.

In particular embodiments, wireless device 110 detects a first status of an object (e.g., itself or another object in proximity of the wireless device) based on dynamic properties of the object (e.g., a heading, a location, a speed, an acceleration, etc.). Wireless device 110 may communicate the first status of the object to a network element (e.g., another wireless device 110, network node 120, server 150, etc.). Later (e.g., at periodic intervals) wireless device 110 may predict a status of the object based on the first status of the object. The prediction may comprise an extrapolation based on the first status (e.g., extrapolate a location based on previous speed and heading). At or near the same time, wireless device 110 may also detect a second status of the object based on dynamic properties of the object. If wireless device 110 determines the predicted status and second status are the same or similar, wireless device 110 does not need to send an update message. Upon determining that the predicted status is different than the second status, wireless device 110 may communicate the second status to the network element.

In wireless network 100, each network node 120 may use any suitable radio access technology, such as long term evolution (LTE), 5G NR, LTE-Advanced, UMTS, HSPA, GSM, cdma2000, NR, WiMax, WiFi, and/or other suitable radio access technology. Wireless network 100 may include any suitable combination of one or more radio access technologies. For purposes of example, various embodiments may be described within the context of certain radio access technologies. However, the scope of the disclosure is not limited to the examples and other embodiments could use different radio access technologies.

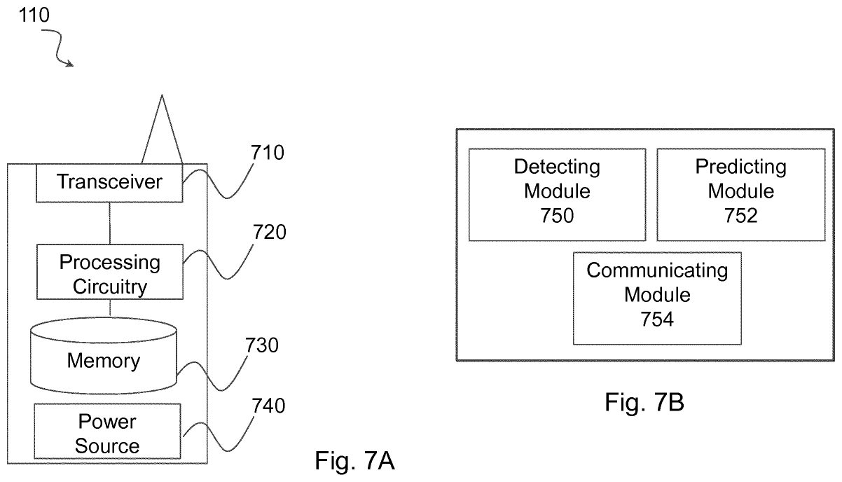

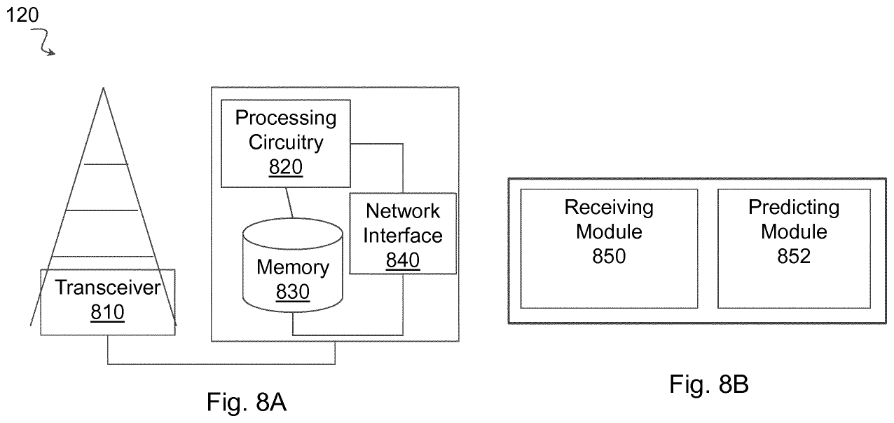

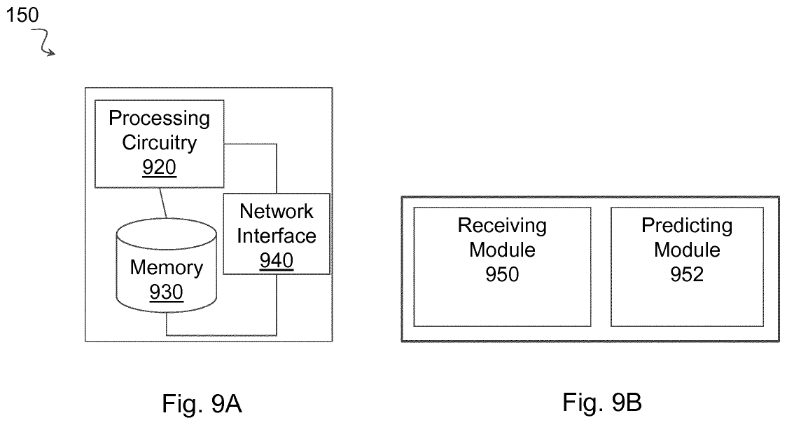

As described above, embodiments of a wireless network may include one or more wireless devices and one or more different types of radio network nodes capable of communicating with the wireless devices. The network may also include any additional elements suitable to support communication between wireless devices or between a wireless device and another communication device. A wireless device may include any suitable combination of hardware and/or software. For example, in particular embodiments, a wireless device, such as wireless device 110, may include the components described with respect to FIG. 7A below. Similarly, a network node may include any suitable combination of hardware and/or software. For example, in particular embodiments, a network node, such as network node 120, may include the components described with respect to FIG. 8A below. In particular embodiments, a server such as server 150 may include the components described with respect to FIG. 9A below.

In general, a transmitter such as wireless device 110, may perform the following steps. At a first time t1, the transmitter detects the status of an object, e.g., its position and speed. The transmitter signals the status of the object to a network element (e.g., a cloud server, RSU, traffic management center, etc.) or to other devices (e.g., wireless device 110, network node 120). At a second time t2, the transmitter determines a predicted status of the object based at least on the previously signaled status of the object. At the same second time t2, the transmitter determines the actual status of the object and compares the predicted and the actual status of the object. If they differ at least in some parameters beyond some threshold, the transmitter triggers the signaling of the actual status of the object.

For example, if the status of the object includes position and speed, a reasonable prediction algorithm consists of: (a) assuming constant speed, the same as the initial one; and (b) extrapolating new positions as a function of time using a linear model, i.e., assuming constant speed while moving from the initial position.

In particular embodiments, the model can be refined if the status includes e.g., acceleration. Although particular examples are described, any prediction model is supported.

Particular embodiments trigger a new transmission of the status messages whenever the predicted status differs from the predicted one. Some embodiments may include additional transmission conditions (e.g., triggering transmissions with some minimum periodicity). Some embodiments may use multiple past statuses for the prediction of the future status.

Particular embodiments include the receiver side, which could be another device (e.g., wireless device 110) or another network element (e.g., a cloud server such as server 150, network node 120, etc.). The receiver may perform the following steps. The receiver may receive a first status of an object, e.g., its position and speed. The receiver may determine a predicted status of the object at later time instances based at least on the previously signaled status of the object. The receiver may receive an updated status of the object that replaces the predicted one.

How the receiver uses the received status information is not described in detail, but it may include ITS applications such as collision avoidance and warning, automated driving, etc.

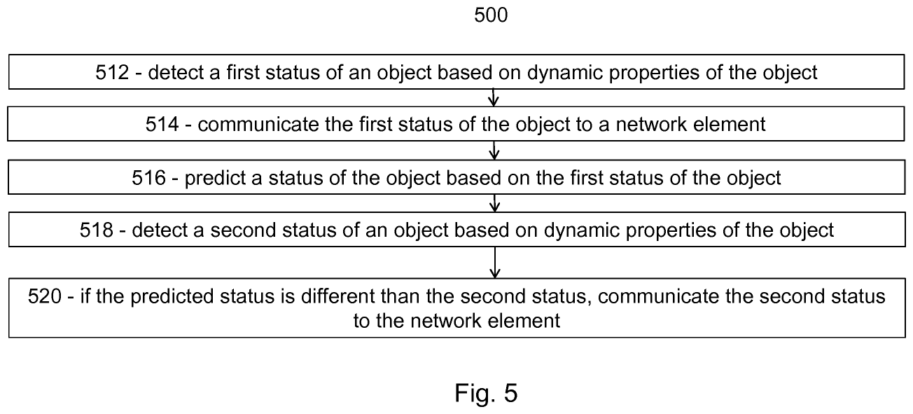

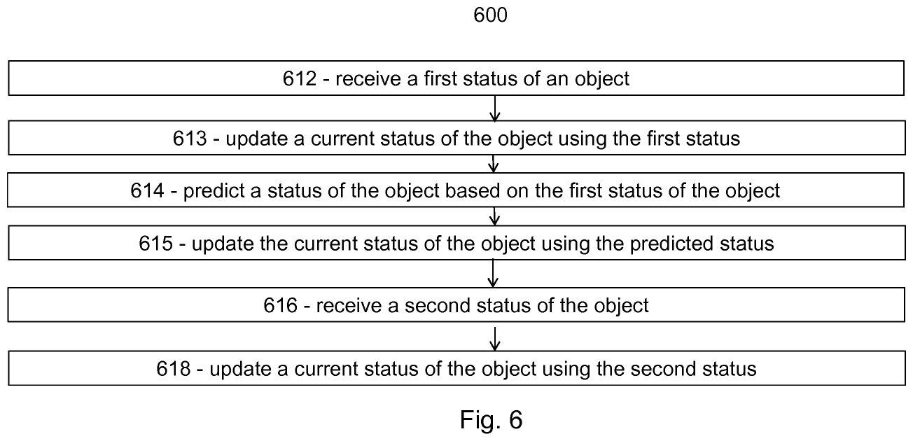

The examples described above may be generally represented by the flowcharts in FIG. 5 (with respect to transmitter, such as a wireless device) and FIG. 6 (with respect to a receiver, such as network node 120, server 150, or another wireless device 110).

FIG. 5 is a flow diagram illustrating an example method in a wireless device, according to some embodiments. In particular embodiments, one or more steps of FIG. 5 may be performed by wireless device 110 described with respect to FIG. 4.

The method begins at step 512, where the wireless device detects a first status of an object based on dynamic properties of the object. For example, wireless device 110 may determine that it is at geographic location X, traveling at a speed S, along a particular heading H. Although particular parameters are used as an example, particular embodiments may base the status of the object on any suitable parameters of the object itself or of the object's environment.

At step 514, the wireless device communicates the first status of the object to a network element. For example, wireless device 110 may signal the first status to another wireless device 110, network node 120, or server 150.

At step 516, the wireless device predicts a status of the object based on the first status of the object. For example, wireless device 110 may predict that it has moved D distance along heading H since the last status determination. The prediction may be based on the assumption that the speed S and heading H remain constant. The status prediction may include a new value for geographic location X. Other embodiments may use any suitable prediction algorithm.

At step 518, the wireless device detects a second status of the object based on dynamic properties of the object. For example, wireless device 110 determines its actual geographic location X, speed S, and heading H.

If wireless device 110 has not changed speed or direction since the determination of the first status, then the predicted status and the second status are likely the same or similar. In which case, the network element that received the first status is also able to accurately predict the status of the wireless device. The wireless device does not need to update the network element, thus conserving bandwidth and network resources.

If wireless device 110 has changed speed or direction since the determination of the first status, then the predicted status and the second status likely do not match. In this case the method continues to step 520.

At step 520, the wireless device communicates the second status to the network element. For example, wireless device 110 communicates the second status to another wireless device 110, network node 120, or server 150.

Modifications, additions, or omissions may be made to method 500. Additionally, one or more steps in method 500 of FIG. 5 may be performed in parallel or in any suitable order. The steps of method 500 may be repeated over time as necessary.

FIG. 6 is a flow diagram illustrating an example method in a network element, according to some embodiments. In particular embodiments, one or more steps of FIG. 6 may be performed by server 150 described with respect to FIG. 4.

The method begins at step 612, where the network element receives a first status of an object. For example, server 150 may receive a first status indicating a geographical location of wireless device 110. In other embodiments, the first status may include any suitable attribute of the wireless device.

At step 613, the network element updates a current status of the object using the first status. For example, server 150 may save the current status of the object in memory 930. Server 150 may use the current status for ITS applications such as collision avoidance and warning, automated driving, etc.

At step 614, the network element predicts a status of the object based on the first status of the object. For example, server 150 may periodically update the status of the object by predicting a new status based on the information in the first status (e.g., predict location based on assumption of same speed and heading). Server 150 may keep updating the status in this manner until a new status is received.

At step 615, the network element updates a current status of the object using the predicted status. For example, server 150 may save the predicted status of the object in memory 930. Server 150 may use the predicted status for ITS applications such as collision avoidance and warning, automated driving, etc.

At step 616, the network element receives a second status of the object. For example, server 150 may receive an updated status for wireless device 110.

At step 618, the network element updates its status of the object using the received second status, instead of a predicted status. In particular embodiments, the network element continues predicting a status of the object based on the second status until another status update is received.

Modifications, additions, or omissions may be made to method 600. Additionally, one or more steps in method 600 of FIG. 6 may be performed in parallel or in any suitable order. The steps of method 600 may be repeated over time as necessary.

FIG. 7A is a block diagram illustrating an example embodiment of a wireless device. The wireless device is an example of the wireless devices 110 illustrated in FIG. 4. In particular embodiments, the wireless device is capable of detecting a status of an object, predicting a status of the object, transmitting a status of the object, comparing a predicted and detected status of the object, and receiving a status of the object.

Particular examples of a wireless device include a mobile phone, a smart phone, a PDA (Personal Digital Assistant), a portable computer (e.g., laptop, tablet), a sensor, a modem, a machine type (MTC) device/machine to machine (M2M) device, laptop embedded equipment (LEE), laptop mounted equipment (LME), USB dongles, a device-to-device capable device, a vehicle-to-vehicle device, or any other device that can provide wireless communication. The wireless device includes transceiver 710, processing circuitry 720, memory 730, and power source 740. In some embodiments, transceiver 710 facilitates transmitting wireless signals to and receiving wireless signals from wireless network node 120 (e.g., via an antenna), processing circuitry 720 executes instructions to provide some or all of the functionality described herein as provided by the wireless device, and memory 730 stores the instructions executed by processing circuitry 720. Power source 740 supplies electrical power to one or more of the components of wireless device 110, such as transceiver 710, processing circuitry 720, and/or memory 730.

Processing circuitry 720 includes any suitable combination of hardware and software implemented in one or more integrated circuits or modules to execute instructions and manipulate data to perform some or all of the described functions of the wireless device. In some embodiments, processing circuitry 720 may include, for example, one or more computers, one more programmable logic devices, one or more central processing units (CPUs), one or more microprocessors, one or more applications, and/or other logic, and/or any suitable combination of the preceding. Processing circuitry 720 may include analog and/or digital circuitry configured to perform some or all of the described functions of wireless device 110. For example, processing circuitry 720 may include resistors, capacitors, inductors, transistors, diodes, and/or any other suitable circuit components.

Memory 730 is generally operable to store computer executable code and data. Examples of memory 730 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

Power source 740 is generally operable to supply electrical power to the components of wireless device 110. Power source 740 may include any suitable type of battery, such as lithium-ion, lithium-air, lithium polymer, nickel cadmium, nickel metal hydride, or any other suitable type of battery for supplying power to a wireless device.

In particular embodiments, processing circuitry 720 in communication with transceiver 710 detects a status of an object, predicts a status of the object, transmits a status of the object, compares a predicted and detected status of the object, and receives a status of the object

Other embodiments of the wireless device may include additional components (beyond those shown in FIG. 7A) responsible for providing certain aspects of the wireless device's functionality, including any of the functionality described above and/or any additional functionality (including any functionality necessary to support the solution described above).

FIG. 7B is a block diagram illustrating example components of a wireless device 110. The components may include detecting module 750, predicting module 752 and communicating module 754.

Detecting module 750 may perform the detecting functions of wireless device 110. For example, detecting module 750 may detect a status of an object according to any of the examples or embodiments described above (e.g., steps 512 and 518 of FIG. 5). In certain embodiments, detecting module 750 may include or be included in processing circuitry 720. In particular embodiments, detecting module 750 may communicate with predicting module 752 and communicating module 754.

Predicting module 752 may perform the predicting functions of wireless device 110. For example, predicting module 752 may predict a status of an object according to any of the examples or embodiments described above (e.g., step 516 of FIG. 5, step 614 of FIG. 6). In certain embodiments, predicting module 752 may include or be included in processing circuitry 720. In particular embodiments, predicting module 752 may communicate with detecting module 750 and communicating module 754.

Communicating module 754 may perform the communicating functions of wireless device 110. For example, communicating module 754 may transmit or receive a status of an object according to any of the examples or embodiments described above (e.g., steps 514 and 520 of FIG. 5, steps 612 and 616 of FIG. 6). In certain embodiments, communicating module 754 may include or be included in processing circuitry 720. In particular embodiments, communicating module 754 may communicate with detecting module 750 and predicting module 752.

FIG. 8A is a block diagram illustrating an example embodiment of a network node. The network node is an example of the network node 120 illustrated in FIG. 4. In particular embodiments, the network node is capable of receiving and predicting status information about an object.

Network node 120 can be an eNodeB, a nodeB, a base station, a wireless access point (e.g., a Wi-Fi access point), a low power node, a base transceiver station (BTS), a transmission point or node, a remote RF unit (RRU), a remote radio head (RRH), or other radio access node. The network node includes at least one transceiver 810, processing circuitry 820, at least one memory 830, and at least one network interface 840. Transceiver 810 facilitates transmitting wireless signals to and receiving wireless signals from a wireless device, such as wireless devices 110 (e.g., via an antenna); processing circuitry 820 executes instructions to provide some or all of the functionality described above as being provided by a network node 120; memory 830 stores the instructions executed by processing circuitry 820; and network interface 840 communicates signals to backend network components, such as a gateway, switch, router, Internet, Public Switched Telephone Network (PSTN), controller, and/or other network nodes 120. Processing circuitry 820 and memory 830 can be of the same types as described with respect to processing circuitry 720 and memory 730 of FIG. 7A above.

In some embodiments, network interface 840 is communicatively coupled to processing circuitry 820 and refers to any suitable device operable to receive input for network node 120, send output from network node 120, perform suitable processing of the input or output or both, communicate to other devices, or any combination of the preceding. Network interface 840 includes appropriate hardware (e.g., port, modem, network interface card, etc.) and software, including protocol conversion and data processing capabilities, to communicate through a network.

In particular embodiments, processing circuitry 820 in communication with transceiver 810 of receives and predicts status information about an object.

Other embodiments of network node 120 include additional components (beyond those shown in FIG. 8A) responsible for providing certain aspects of the network node's functionality, including any of the functionality described above and/or any additional functionality (including any functionality necessary to support the solution described above). The various different types of network nodes may include components having the same physical hardware but configured (e.g., via programming) to support different radio access technologies, or may represent partly or entirely different physical components.

FIG. 8B is a block diagram illustrating example components of network node 120. The components may include receiving module 850 and predicting module 852.

Receiving module 850 may perform the receiving functions of network node 120. For example, receiving module 850 may receive status information about an object according to any of the examples or embodiments described above (e.g., steps 612 and 616 of FIG. 6). In certain embodiments, receiving module 850 may include or be included in processing circuitry 820. In particular embodiments, receiving module 850 may communicate with predicting module 852.

Predicting module 852 may perform the predicting functions of network node 120. For example, predicting module 852 may predict a status of an object according to any of the examples or embodiments described above (e.g., FIG. 614 of FIG. 6). In certain embodiments, predicting module 852 may include or be included in processing circuitry 820. In particular embodiments, predicting module 852 may communicate with receiving module 850.

FIG. 9A is a block diagram illustrating an example embodiment of a server. The server is an example of server 150 illustrated in FIG. 4. In particular embodiments, the server is capable of receiving and predicting a status of an object.

The server includes processing circuitry 920, at least one memory 930, and at least one network interface 940. In some embodiments, processing circuitry 920 executes instructions to provide some or all of the functionality described herein as provided by the server. Memory 930 stores the instructions executed by processing circuitry 920. Network interface 940 communicates signals to other network components, such as a gateway, switch, router, Internet, Public Switched Telephone Network (PSTN), controller, network nodes 12, and other servers 150.

Processing circuitry 920 includes any suitable combination of hardware and software implemented in one or more integrated circuits or modules to execute instructions and manipulate data to perform some or all of the described functions of the server. In some embodiments, processing circuitry 920 may include, for example, one or more computers, one more programmable logic devices, one or more central processing units (CPUs), one or more microprocessors, one or more applications, and/or other logic, and/or any suitable combination of the preceding. Processing circuitry 920 may include analog and/or digital circuitry configured to perform some or all of the described functions of server 150. For example, processing circuitry 920 may include resistors, capacitors, inductors, transistors, diodes, and/or any other suitable circuit components.

Memory 930 is generally operable to store computer executable code and data. Examples of memory 930 include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or or any other volatile or non-volatile, non-transitory computer-readable and/or computer-executable memory devices that store information.

In some embodiments, network interface 940 is communicatively coupled to processing circuitry 920 and refers to any suitable device operable to receive input for server 150, send output from server 150, perform suitable processing of the input or output or both, communicate to other devices, or any combination of the preceding. Network interface 940 includes appropriate hardware (e.g., port, modem, network interface card, etc.) and software, including protocol conversion and data processing capabilities, to communicate through a network.

In particular embodiments, processing circuitry 920 in communication with transceiver 910 receives and predicts status information about an object.

Other embodiments of the server may include additional components (beyond those shown in FIG. 9A) responsible for providing certain aspects of the server's functionality, including any of the functionality described above and/or any additional functionality (including any functionality necessary to support the solution described above).

FIG. 9B is a block diagram illustrating example components of a server 150. The components may include receiving module 950 and predicting module 952.

Receiving module 950 may perform the receiving functions of server 150. For example, receiving module 950 may receive status information about an object according to any of the examples or embodiments described above (e.g., steps 612 and 616 of FIG. 6). In certain embodiments, receiving module 950 may include or be included in processing circuitry 920. In particular embodiments, receiving module 950 may communicate with predicting module 952.

Predicting module 952 may perform the predicting functions of server 150. For example, predicting module 952 may predict a status of an object according to any of the examples or embodiments described above (e.g., FIG. 614 of FIG. 6). In certain embodiments, predicting module 952 may include or be included in processing circuitry 920. In particular embodiments, predicting module 952 may communicate with receiving module 950.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the claims below.

Abbreviations used in the preceding description include:

3D Three Dimensional

3GPP Third Generation Partnership Project

BTS Base Transceiver Station

CAM Cooperative Awareness Message

C-MTC Critical Machine Type Communication

D2D Device to Device

DENM Decentralized Environmental Notification Message

DL Downlink

DSRC Dedicated short-range communications

eNB eNodeB

EPS Evolved Packet System

FDD Frequency Division Duplex

ITS Intelligent Transport System

LTE Long Term Evolution

MAC Medium Access Control

M2M Machine to Machine

MIMO Multi-Input Multi-Output

MTC Machine Type Communication

NR New Radio

PDSCH Physical Downlink Shared Channel

ProSe Proximity Services

PUCCH Physical Uplink Control Channel

RAN Radio Access Network

RAT Radio Access Technology

RB Radio Bearer

RBS Radio Base Station

RNC Radio Network Controller

RRC Radio Resource Control

RRH Remote Radio Head

RRU Remote Radio Unit

RSU Roadside Unit

SNR Signal-to-Interference-plus-Noise Ratio

TDD Time Division Duplex

UE User Equipment

UL Uplink

UTRAN Universal Terrestrial Radio Access Network

V2X Vehicle-to-Everything

V2V Vehicle-to-Vehicle

V2P Vehicle-to-Pedestrian

V2I Vehicle-to-Infrastructure

WAN Wireless Access Network

WAVE Wireless Access in Vehicular Environments

1. A method for use in a wireless device, the method comprising:
detecting, at a first time period, a first status of an object based on dynamic properties of the object;
communicating the first status of the object to a network element;
predicting, at a second time period after the first time period, a status of the object based on the first status of the object;
detecting, at the second time period, a second status of the object based on dynamic properties of the object; and
upon determining that the predicted status is different than the second status, communicating the second status to the network element.

2. The method of claim 1, wherein the dynamic properties of the object comprise at least one of a heading, a location, a speed, and an acceleration.

3. The method of claim 1, wherein determining that the predicted status is different than the second status comprises determining that the predicted status and the second status differ by at least a threshold amount.

4. The method of claim 1, wherein predicting the status of the object comprises a linear extrapolation of the first status.

5. The method of claim 1, wherein the method further comprises upon determining a threshold amount of time has passed since communicating the first status of the object to the network element, communicating the second status to the network element.

6. The method of claim 1, wherein the object is the wireless device.

7. The method of claim 1, wherein the object is an object in proximity to the wireless device.

8. The method of claim 1, wherein the network element comprises at least one of another wireless device, a network node, and a cloud server.

9. The method of claim 1, wherein the object comprises a vehicle.

10. The method of claim 1, wherein communicating the first or second status comprises sending a cooperative awareness message (CAM).

11. A wireless device comprising processing circuitry operable to:
detect, at a first time period, a first status of an object based on dynamic properties of the object;
communicate the first status of the object to a network element;
predict, at a second time period after the first time period, a status of the object based on the first status of the object;
detect, at the second time period, a second status of the object based on dynamic properties of the object; and
upon the processing circuitry determining that the predicted status is different than the second status, the processing circuitry is operable to communicate the second status to the network element.

12. The wireless device of claim 11, wherein the processing circuitry is operable to implement the invention according to claim 2.

13.-20. (canceled)

21. A method for use in a network element, the method comprising:
receiving, from a wireless device, a first status of an object at a first time period;
updating a current status of the object using the first status;
predicting, at a second time period after the first time period, a status of the object based on the first status of the object;
updating the current status of the object using the predicted status;
receiving a second status of the object, the second status different than the predicted status; and
updating the current status of the object using the second status.

22.-28. (canceled)

29. A network element comprising processing circuitry operable to:
receive, from a wireless device, a first status of an object at a first time period;
update a current status of the object using the first status;
predict, at a second time period after the first time period, a status of the object based on the first status of the object;
update the current status of the object using the predicted status;
receive a second status of the object, the second status different than the predicted status; and
update the current status of the object using the second status.

30.-38. (canceled)
